(19) United States
(12) Patent Application Publication
(10) Pub. No.: US 2024/0368918 A1
(43) Pub. Date: Nov. 7, 2024

(54) HANDLE FOR OPENING AND/OR CLOSING A VEHICLE DOOR

(71) Applicant: MINEBEA ACCESSSOLUTIONS ITALIA S.P.A., Pianezza (IT)

(72) Inventors: Marco SAVANT, PIANEZZA (IT); Anthony GUERIN, PIANEZZA (IT); Antonino CANNAVO, PIANEZZA (IT)

(73) Assignee: MINEBEA ACCESSSOLUTIONS ITALIA S.P.A., Pianezza (IT)

(21) Appl. No.: 18/769,607

(22) Filed: Jul. 11, 2024

Related U.S. Application Data
(63) Continuation of application No. PCT/EP2023/050493, filed on Jan. 10, 2023.

(30) Foreign Application Priority Data
Jan. 11, 2022 (EP) 22150936.7

(51) Int. Cl. E05B 81/76; E05B 17/18

(52) U.S. Cl. CPC E05B 81/76; E05B 17/185

(57) ABSTRACT

A handle for a vehicle door includes a cover member configured to be secured to a bracket. The cover member includes an access part to a mechanical lockset, the access part having an opening through which the mechanical lockset can be accessed, defining an opening axis passing through the opening, and a cover element configured to be movable between a locked position and an unlocked position, so that when in the unlocked position, the cover element can be moved away from to the opening such that the mechanical lockset can be accessed. The cover element is configured to be moved from the unlocked position to the unlocked position by rotating the cover element with respect to the access part according to the opening axis.

### CROSS-REFERENCE TO RELATED APPLICATIONS

This application is a continuation of International Application No. PCT/EP2023/050493, filed on Jan. 10, 2023, which claims priority to and the benefit of EP application Ser. No. 22/150,936.7, filed on Jan. 11, 2022. The disclosures of the above applications are incorporated herein by reference.

### FIELD

The present disclosure relates to a handle for opening and/or closing a vehicle door and to an assembly for opening and/or closing a vehicle door comprising the handle, in particular to an electronic assembly for opening and/or closing the vehicle door.

### BACKGROUND

The statements in this section merely provide background information related to the present disclosure and may not constitute prior art.

Electronic assemblies for opening and/or closing a vehicle door generally comprise a handle, a bracket to which the handle is secured and electronic means configured to activate a latch, such as an electronic latch, to open the vehicle door.

These assemblies generally also comprise mechanical lockset so that in case of electronic failure, the vehicle door can be manually and mechanically opened, by means of the mechanical lockset. This mechanical lockset is often accessible from behind the handle.

As this mechanical lockset is only used as a back-up device, vehicle manufacturers often seek to arrange the handle such that the mechanical lockset is easily accessible while being the least visible on the assembly.

### SUMMARY

This section provides a general summary of the disclosure and is not a comprehensive disclosure of its full scope or all of its features.

An object of the invention is to provide a handle for opening and/or closing a vehicle door arranged such that the mechanical lockset is the least visible while being easy to access.

To this end, the invention relates, according to a first aspect, to a handle for opening and/or closing a vehicle door, the handle comprising a cover member configured to be secured to a bracket, the cover member comprising:
a frame part, and
an inner wall part extending from the frame part
characterized in that the cover member comprises:
an access part, the access part having an opening through which the mechanical lockset can be accessed, the opening defining an opening axis extending from one side of the opening to the other side of the opening,
a cover element configured to cover the opening, the cover element being configured to be movable between a locked position and an unlocked position, so that when in the unlocked position, the cover element can be moved away from the opening such that the mechanical lockset can be accessed, the cover element being configured to be moved from the locked position to the unlocked position by rotating the cover element with respect to the access part according to the opening axis.

For example, the inner wall part extends from the frame part so as to allow access by a user's hand to at least one electronic switch of the bracket.

For example, the at least one electronic switch is configured to be activated by a user's touch to send a signal to an electronic latch to open the door.

The opening of the access to the mechanical lockset can be covered by the cover member so that the mechanical lockset is hidden when the mechanical lockset is not to be used. This allows to provide an aesthetic assembly on the vehicle door.

Furthermore, the configuration of the cover element moveable by rotation permits to provide an easy and fast way to cover the opening of the access with the cover element or to move the cover element away from the opening to allow an access to the mechanical lockset.

The handle can include the following features, considered alone or in any technically possible combination:

The access part is arranged on the inner wall part of the cover member. The access part is the thus the least visible on the handle.

The cover element includes at least one mounting and/or dismounting means and the access part comprises at least one complementary mounting and/or dismounting means disposed at the opening. The at least one mounting and/or dismounting means of the cover element and the at least one complementary mounting and/or dismounting means of the access part cooperate with each other in the locked position.

The at least one mounting and/or dismounting means is a first part of a bayonet mounting and/or dismounting means and the at least second mounting and/or dismounting means is a second part of a bayonet mounting and/or dismounting means.

The at least one mounting and/or dismounting means of the cover member and the at least one complementary mounting and/or dismounting means of the access part cooperate with each other by clipping.

The cover element includes a slot adapted for receiving a mechanical key such that the cover element can be rotated between the locked position and unlocked position by the mechanical key.

The assembly includes a connecting element connecting the cover element to another part of the cover member so that the cover element remains connected to the cover member even when the cover element is moved away from the opening such that the mechanical lockset can be accessed.

The cover member includes guiding means configured to guide the cover element when the cover element is moved to the locked position.

The guiding means includes a guide rail and a guide shoe, the access portion comprising the guide rail, and the cover element comprising the guide shoe, the guide shoe being configured to cooperate with the guide rail.

According to a second aspect, the invention concerns an assembly for opening and/or closing a vehicle door, the assembly including: a bracket configured to be assembled to an inner side of the door, the bracket comprising at least one electronic switch configured to be activated by a user's touch to send a signal to an electronic latch to open the door, and a handle as previously described.

According to a third aspect, the invention concerns a method for opening a vehicle door by means of such assembly, the method comprising a step of moving the cover element from the locked position to the unlocked position by rotating the cover element with respect to the access part according to the opening axis.

The method can further include the step of moving the cover element in the unlocked position away from to the opening such that the mechanical lockset can be accessed.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows a handle according to an example of an embodiment of the invention.

FIG. 2 shows a portion of the cover member of the handle of FIG. 1.

FIG. 3 shows an opening of the cover member of FIG. 2.

FIG. 4 shows a cover element of the assembly of FIG. 1.

FIG. 5 shows a rear view of the assembly of FIG. 1.

FIG. 6 shows a detail of the rear view of FIG. 5.

FIG. 7 shows the detail of FIG. 6 following another perspective, wherein the cover element is in a locked position.

FIG. 8 shows the cover element in an unlocked position.

FIG. 9 shows the handle of FIG. 1 upon insertion of a key in the cover element.

FIG. 10 shows a portion of the handle of FIG. 1.

FIG. 11 shows another portion of the handle of FIG. 1.

FIG. 12 shows an assembly according to an example of an embodiment of the invention.

FIG. 13 shows a handle and a bracket of the assembly of FIG. 12 before mounting on a vehicle door.

FIG. 14 shows the bracket of the assembly of FIG. 12 assembled to the vehicle door.

FIG. 15 shows a rear view of the assembly of FIG. 12.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

### Handle

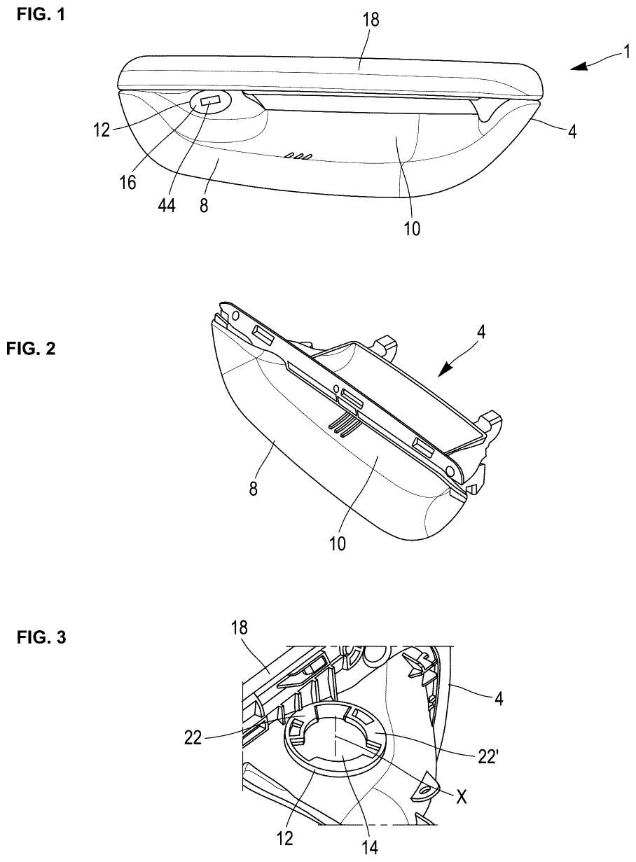

FIG. 1 illustrates a handle 1 for opening and/or closing a vehicle door according to the invention.

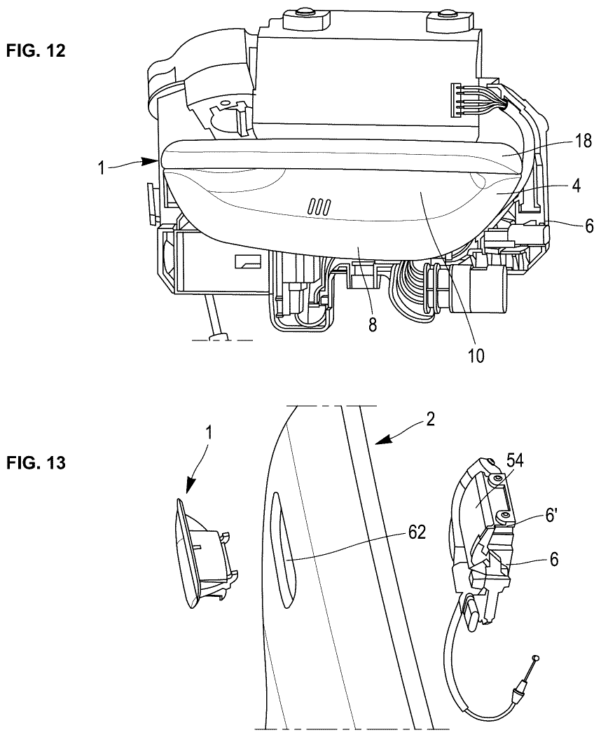

The handle 1 for opening and/or closing a vehicle door 2 (FIG. 13) comprises a cover member 4 configured to be secured to a bracket 6 (FIG. 12). The cover member 4 comprises a frame part 8. The cover member 4 comprises an inner wall part 10 extending from the frame part 8.

The cover member 4 comprises an access part 12. The access part 12 has an opening 14 (FIG. 3), the opening 14 defining an opening axis X. The opening axis X can extend from one side of the opening 14 to the other side of the opening. The opening axis X can pass through the opening 14. For example, the axis X connects the two spaces extending from each part of the cover member 4 and passes through the opening 14. The opening axis X is for instance a radial axis of the opening.

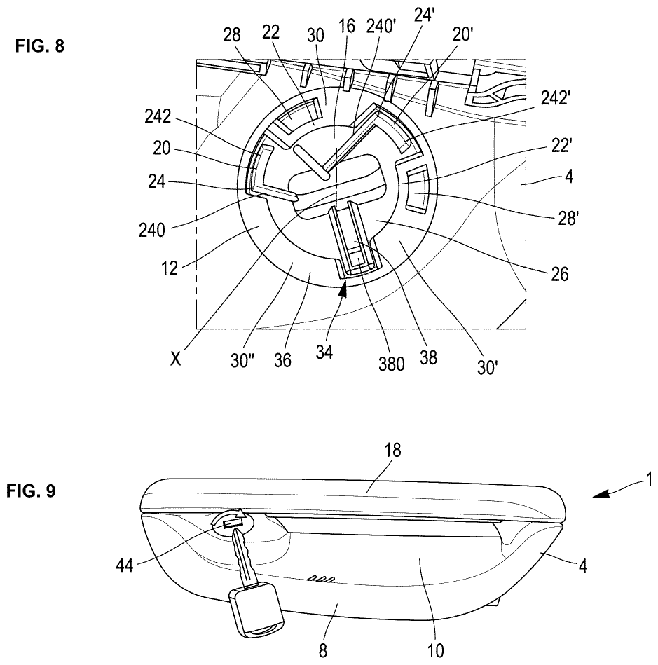

The cover member 4 comprises a cover element 16 configured to cover the opening 14. The cover element 16 is configured to be movable between a locked position (FIG. 7) and an unlocked position (FIG. 8), so that when in the unlocked position, the cover element 16 can be moved away from the opening 14, the cover element 16 being configured to be moved from the locked position (FIG. 7) to the unlocked position (FIG. 8) by rotating the cover element 16 with respect to the access part 12 according to the opening axis X.

The opening axis refers to the mathematical axis around which the cover element 16 is configured to rotate with respect to the access part 12 to be moved from the locked position to the unlocked position.

It is thus possible to easily gain access to a specific part or device of the vehicle door even when an electronic system of the vehicle door 2, for instance the electronic system responsible for unlocking and/or opening the vehicle door 2, is not functional. For instance, it is thus easy to gain access to a backup device, such as a mechanical lockset.

The rotating movement about the opening axis X makes it easy to make such access possible when wanted, while preventing access to be made unintentionally, for instance by mistake when touching the corresponding part of the handle.

This opening mechanism also allows for reduced volume of the parts necessary to allow such access. Therefore, access to a device such as a backup device is made possible while the corresponding mechanical parts take limited space within the door handle.

### Mechanical Lockset

The access part 12 is an access part to a mechanical lockset (not shown) and the cover element 16 can be moved away from to the opening 14 such that the mechanical lockset can be accessed.

For example, the mechanical lockset can be arranged on the vehicle door 2 or on the bracket 6.

The mechanical lockset is a back-up device so that in case of electronic failure, the vehicle door 2 can be manually and mechanically opened, by means of the mechanical lockset.

To this end, the handle 1 comprises a gripping means 18 configured to be graspable by the user's hand to manually open the vehicle door.

For example, the gripping means 18 is arranged on the frame part 8 of the cover element 16.

For example, the gripping means 18 is a strip such as a chrome strip.

### Cover Element

According to an embodiment of the invention, the access part 12 is arranged on the inner wall part 10 of the cover member 4. The access part is the least visible on the handle, for instance from the user's side of the vehicle door, for instance a user's point of view from outside the vehicle when the handle is mounted on the vehicle door and the vehicle door 2 is mounted on the vehicle. The inner wall part 10 can for instance comprise a wall part and a guide part. The access part 12 is arranged on the wall part. The guide part forms a guide extending so as to allow access by a user's hand to at least one electronic switch of the bracket 6 as described hereafter. The guide part is for instance arranged sideways with respect to the guide part, for instance such that the wall part extends upstream a path of the guide part going downstream towards the electronic switch.

Upstream, respectively downstream, means for example with respect to a sense going from the outside of the handle towards the electronic switch, for instance with respect to the sense going from the frame part to the electronic switch, for instance with respect to the movement of the user's hand reaching for the electronic switch.

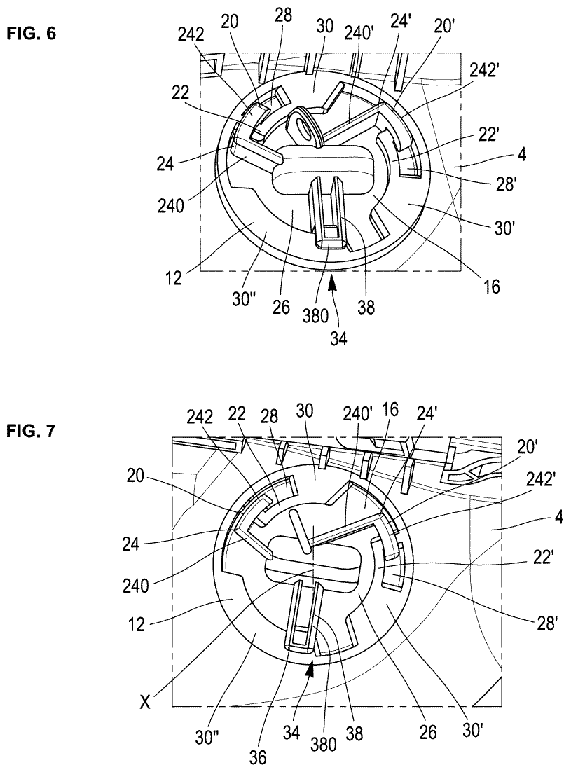

As illustrated in FIGS. 6, the cover element 16 comprises at least one mounting and/or dismounting means 20, 20′ and the access part comprises at least one complementary mounting and/or dismounting means 22, 22′ disposed at the opening 14.

The at least one mounting and/or dismounting means 20, 20′ of the cover element 16 and the at least one complementary mounting and/or dismounting means 22, 22′ of the access part 12 are configured to cooperate with each other in the locked position.

For example, the at least one mounting and/or dismounting means 20, 20′ of the cover element 16 is a first part of a bayonet mounting and/or dismounting means and the at least one complementary mounting and/or dismounting means 22, 22′ of the access part is a second part of a bayonet mounting and/or dismounting means.

According to the invention, the at least one mounting and/or dismounting means 20, 20′ of the cover element 16 is or comprises a lug or ridge 24, 24′ or any other suitable element configured to ensure a rotation stop.

The lug 24, 24′ is arranged on a first side 26 of the cover element 16 and protrudes with respect to the first side 26 of the cover element 16. The first side 26 can for instance correspond to a side that is opposite to a second side accessible to the user. The first side 26 can be an inner side facing away from the outside of the vehicle door 2 when the vehicle door 2 is mounted on the vehicle. The opening 14 can for instance connect the first side and the second side. The opening axis X can for instance connect the first side and the second side.

For example, the lug 24, 24′ comprises a first portion 240, 240′ and a second portion 242, 242′, tilted with respect to the first portion 240, 240′. The first portion 240, 240′ can extend away from a central part of the cover element 16 from a central extremity to a peripheral extremity. The second portion 242, 242′ can extend from the peripheral extremity of the first portion 240, 240′. For example, the second portion 242, 242′ extends from a proximal portion thereof, connected to the peripheral extremity, to an extremal portion thereof. For example, second portion 242, 242′ comprises a connecting portion connecting the proximal portion and the extremal portion.

The central part of the cover element 16 may present a protrusion. The protrusion can be formed by a slot 44 as described hereunder, the slot 44 extending on the other side of the cover element 16. The first portion 240, 240′, for instance the central extremities thereof, can extend from the protrusion. The protrusion have an elongated shape. The protrusion ensures that the slot 44 is closed, thus preventing dirt to enter that way.

The at least one complementary mounting and/or dismounting means 22, 22′ of the access part 12 can be or comprise a housing 28, 28′ arranged on a wall 30, 30′ of the cover member. The housing 28, 28′ can be arranged at the level of opening 14, for instance around the opening 14. The housing 28, 28′ can form an aperture, for instance an opening within the wall 30, 30′, for instance an opening connecting the first side and the second side.

The housing 28, 28′ is configured to receive at least a portion of the lug 24, 24′, for example at least a portion of the second portion 242, 242′ of the lug 24, 24′, for instance the extremal portion thereof, so that the lug 24, 24′ ensures a rotation stop when received in the housing 28, 28′, for example in the locked position. To this extent, the connecting portion is for example thinner than the extremal portion and/or the extremal portion and the connecting portion are arranged so as to form a hook, for instance the extremal portion extending from the connecting portion so as to be directed back towards a face of the first side of the cover element and/or towards the second side of the cover element, for example facing away from the mechanical lockset.

According to an embodiment of the invention, the cover element comprises two mounting and/or dismounting means 20, 20′ and the access portion comprises two complementary mounting and/or dismounting means 22, 22′ disposed at the opening 14.

According to this embodiment, the cover element comprises a first mounting and/or dismounting means 20 and second mounting dismounting means 20′ and the access part comprises a first complementary mounting and/or dismounting means 22 and a second complementary mounting and/or dismounting means 22′, disposed at the opening 14.

The first mounting and/or dismounting means 20 of the cover element and the first complementary mounting and/or dismounting means 22 of the access part cooperate with each other in the locked position, and the second mounting and/or dismounting means 20′ of the cover element and the second complementary mounting and/or dismounting means 22′ of the access part cooperate with each other in the locked position.

The mounting and/or dismounting means of the cover member and the complementary mounting and/or dismounting means of the access part cooperate with each other by clipping.

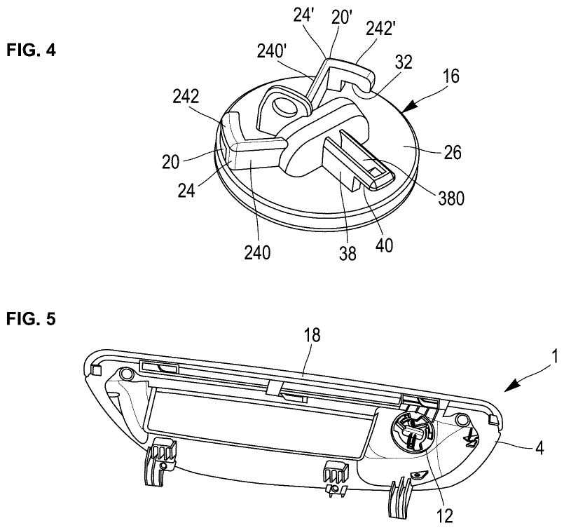

For example, the at least one lug 24, 24′ comprises a recess 32 (FIG. 4) configured to cooperate with the walls 30, 30′ of the access part. For example, when the extremal portion is received in the housing 28, 28′, in the locked position, the recess result in the connecting portion forms a bridge connecting the proximal portion and the extremal portion over a portion of the access part separating the opening 14 and the aperture of the housing 28, 28′.

The cover member 4 comprises guiding means 34 configured to guide the cover element 16 when the cover element is moved to the locked position.

The guiding means 34 comprises a guide rail 36 and a guide shoe 38, the access part 12 comprising the guide rail 36, and the cover element 16 comprising the guide shoe 38.

The guide shoe 38 is configured to cooperate with the guide rail 36.

For example, the guide rail 36 is a third wall 30″ disposed at the opening 14.

For example, the guide shoe 38 comprises an arm 380 arranged on a first side 26 of the cover element 16 and protrudes with respect to the first side of the cover element.

The arm 380 comprises an end comprising a notch 40 (FIG. 4) so that the arm 380 can cooperate with the third wall 30″ of the guide rail.

As illustrated in FIGS. 6, 7 and 8, the access part 12 comprises a housing 42 arranged between two walls 30′, 30″ disposed at the opening. This housing 42 permits to guide the cover element with respect to the opening when the cover element is assembled to the opening to cover the opening.

As illustrated in FIGS. 1 and 9, the cover element 16 comprises a slot 44 adapted for receiving a mechanical key such that the cover element 16 can be rotated between the locked position and unlocked position by the mechanical key.

For instance, in the unlocked position, the cover element can be moved away from the opening by pulling and/or pushing the cover element, for instance with the help of a mechanical key inserted therein. The handle can be configured such that in the unlocked position, the cover element 16 is in an instable equilibrium position such that it tends to fall when solicited, for instance solicited by pulling and/or pushing, for instance with the help of a mechanical key inserted therein. The handle can be configured such that the cover element 16 is press fit with respect the cover member 4, for example the press fit being undone upon reaching the unlocked position, and/or by pulling and/or pushing the cover element 16, for instance with the help of a mechanical key inserted therein, thus resulting in the cover element 16 being moved away from the opening.

For instance, the mechanical key, once inserted, can cooperate with the slot so as to allow pulling of the cover element when pulling the key towards the user's side.

### Connecting Element

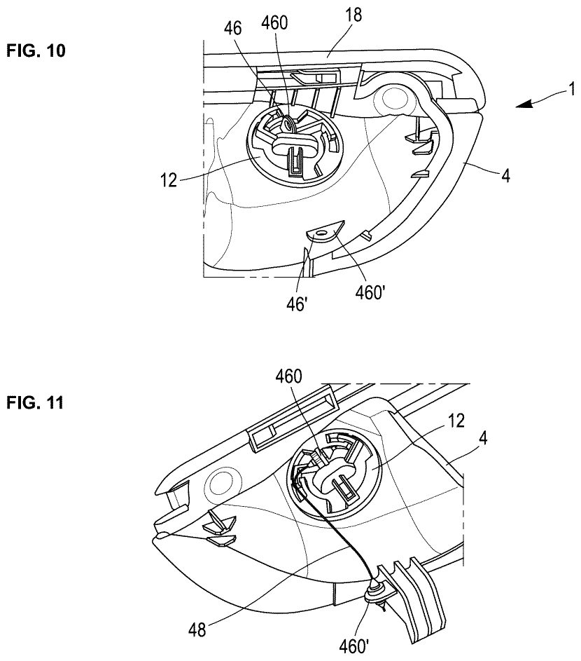

As illustrated in FIG. 10, the handle 1 comprises a connecting element 48 connecting the cover element 16 to another part of the cover member 4 so that the cover element 16 remains connected to the cover member 4 even when the cover element 16 is moved away from the opening 14 such that the mechanical lockset can be accessed.

The connecting element allows easy retrieval of the cover element when it is not in the locked position.

According to the present invention, the connecting element allows the cover element to be moved with respect to the another part of the cover member while remaining at a predetermined maximum distance thereof.

Within such limitations, it is to be understood that the connecting element 48 does not prevent the cover element from being moved freely in translations and rotations with respect to the another part.

According to the present invention, the cover element 16 comprises a first retaining element 460 configured to retain a first portion of the connecting element 48, and the cover member 4 comprises a second retaining element 460′ configured to retain a second portion of the connecting element 48, such that the cover element is linked to the cover member if the cover element is dismounted from the opening.

The second retaining element 460′ can form the another part of the cover member. The second retaining element 460′ can for example extend from one of the clipping means 58, 58′ described hereafter.

The connecting element 48 can comprise or form a wire and/or a chain.

As illustrated in FIG. 11, the connecting element 48 connects the cover element 16 to another part of the cover member 4. The connecting element 48 comprises a first end secured to the first retaining element 460 of the cover element end a second end secured to the second retaining element 460′ of the cover member.

The first retaining element 460, and/or respectively the second retaining element 460′, can have a hole for retaining the first portion of the connecting element 48, and/or respectively the second portion of the connecting element 48.

The first retaining element can extend from the central part of the cover element 16, for instance from the protrusion. The first retaining element can extend from the central extremity of the first portion 240′.

### Bracket

FIG. 12 illustrates an assembly for opening and/or closing according to the present invention.

The assembly 100 comprises a bracket 6 configured to be assembled to an inner side of the vehicle door 2. The bracket 6 comprises at least one electronic switch configured to be activated by a user's touch to send a signal to an electronic latch to open the door. The assembly 100 comprises the handle as previously described.

According to the invention, the bracket 6 is configured to be assembled to the inner side of the vehicle door 50.

By “assembled to the inner side”, it is to be understood that the bracket 6 can be fixed or attached or assembled by any suitable means to the inner side of the vehicle door 2.

By “inner side of the door”, it is understood for example the side of the door destined to face the vehicle interior, by opposition to an outer side of the door destined to be disposed towards the exterior environment.

For example, as illustrated in FIG. 6, the bracket is fixed to the inner side of the door 2 by means of screws 52, 52′. For example, the bracket 6 is fixed to the inner side of the vehicle door by means a first screw 56 and second screw 56′.

As illustrated in FIG. 6, the bracket 56 is positioned against the inner side of the vehicle door.

The bracket 6 comprises at least one electronic switch configured to be activated by a user's touch, for example, by mean of a user's finger touch.

When activated by the user's touch, the electronic switch sends a signal to an electronic latch (not shown) so that the electronic latch open the vehicle door 2.

As illustrated in FIGS. 13, the at least one switch is arranged on an upper part 6′ of the bracket 6.

The at least one switch is arranged behind a casing 54 arranged on the upper part 6′ of the bracket 6.

The cover member 4 is configured to be secured to the bracket 6.

To this end, the bracket 6 and the cover member 4 comprise complementary fastening means which cooperate with each other so that the cover member can be secured to the bracket.

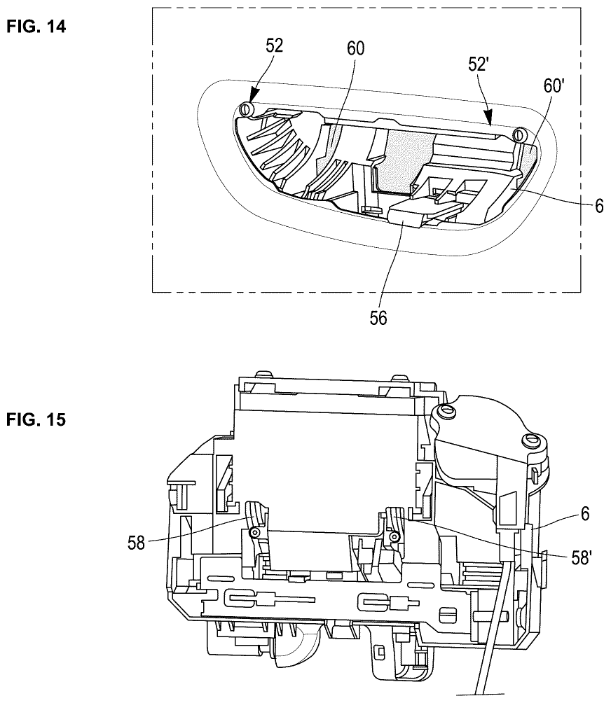

For example, the bracket 6 comprises clipping means 56 (FIG. 14) and the cover member 4 comprises at least one housing (not visible) configured to receive the clipping means 56 of the bracket 6. The bracket 6 can comprise at least one aperture, the assembly being configured such that the clipping means 56 can be inserted through at least one aperture of the bracket 6, for example so as to reach the at least one housing.

As illustrated in FIG. 15, the cover member 4 comprises two clipping means 58, 58′ and the bracket 6 comprises two corresponding housings 60, 60′ (FIG. 14) each configured to receive one of the clipping means 58, 58′ of the cover member 4.

For instance, the assembly is configured such that the cover member 4 can be locked in position to the bracket 6. To this extent, the bracket 6 can comprise a locking element. The locking element can be configured such that a sliding of the locking element with respect to a body of the bracket allows for locking the cover member on the bracket 6. The locking can result from the locking element being positioned at least partially between the clipped clipping means 58, 58′ and the aperture.

As illustrated in FIG. 13, the cover member 48 is configured to be assembled to the external side of the vehicle door 2, opposite to the inner side of the door.

To this end, the vehicle door 2 comprises an opening 62 (FIG. 13) so that the cover member 4 can be assembled to the external side of the door and secured to the bracket 6.

The frame part 8 is sized so that a user's hand can passes through the frame part 8.

The frame part 8 is configured to be positioned against the external side of the vehicle door.

The inner wall part 10 of the cover member 4 extends from the frame part 8. The inner wall part 10 extends from the frame part 8 so as to allow access by the user's hand the at least one electronic switch of the bracket when the handle is secured to the bracket. The inner wall part can form a guide to the at least one electronic switch.

To this end, the inner wall part 10 can be tilted with respect to the frame part 8. This configuration permits to guide the user's hand toward the at least one electronic switch arranged on the upper part of the bracket 6.

By “upper”, respectively “lower”, it is for example understood with respect to a vertical axis, for example the axis orthogonal to the ground when the vehicle is on a flat ground.

For example, the inner wall part is curved (FIG. 2).

The frame part 8 and the tilted inner wall part 10 may form a bowl shape element. For instance, the frame part 10 and the tilted inner wall part may form a handle of the bowl type, for instance a bowl-shaped handle.

The frame part 8 and the inner wall part 10 can be made integrally.

The mechanical lockset is arranged on the bracket 6 (not visible).

The opening 14 of the access part 12 allows an access to the mechanical lockset arranged on the bracket.

The cover element 16 hide the opening 14.

In case of electronic failure, the user removes the cover element 16 from the opening 14 of the access part 12 so that the mechanical lockset can be accessed.

The vehicle door can be unlocked using a mechanical key inserted in the mechanical lockset.

The user can pull on the strip 18 of the handle 1 to open the vehicle door manually.

### System

A system can comprise such an assembly 100 and the corresponding vehicle door. The assembly is assembled to the vehicle door. The assembly can further comprise the vehicle including the vehicle door mounted thereon.

The system can comprise the mechanical lockset. The system can comprise the mechanical key configured to cooperate with the mechanical lockset and/or with the slot.

### Method

A method for opening a vehicle door by means of the assembly as previously described comprises a step of moving the cover element 16 from the locked position to the unlocked position by rotating the cover element 16 with respect to the access part 12 according to the opening axis X.

The method for opening further comprises a step of moving the cover element 16 in the unlocked position away from to the opening 14 such that the mechanical lockset can be accessed.

The method for opening further comprises a step of accessing the mechanical lockset with the corresponding mechanical key and having the mechanical lockset and the mechanical key cooperate so as to open the door.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A handle for opening and/or closing a vehicle door, the handle comprising a cover member configured to be secured to a bracket, the cover member comprising:
a frame part; and
an inner wall part extending from the frame part so as to allow access by a user's hand to at least one electronic switch of the bracket, the at least one electronic switch being configured to be activated by a user's touch to send a signal to an electronic latch to open the door,
wherein the cover member further comprises:
an access part to a mechanical lockset, the access part having an opening through which the mechanical lockset can be accessed, the opening defining an opening axis passing through the opening; and
a cover element configured to cover the opening, the cover element being configured to be movable between a locked position and an unlocked position, so that when in the unlocked position, the cover element can be moved away from to the opening such that the mechanical lockset can be accessed, the cover element being configured to be moved from the locked position to the unlocked position by rotating the cover element with respect to the access part according to the opening axis.

2. The handle according to claim 1 wherein the access part is arranged on the inner wall part of the cover member.

3. The handle according to claim 1, wherein the cover element comprises at least one mounting and/or dismounting means and wherein the access part comprises at least one complementary mounting and/or dismounting means disposed at the opening, such that the at least one mounting and/or dismounting means of the cover element and the at least one complementary mounting and/or dismounting means of the access part cooperate with each other in the locked position.

4. The handle according to claim 3, wherein the at least one mounting and/or dismounting means includes a first part of a bayonet mounting and/or dismounting means and a second part of the bayonet mounting and/or dismounting means.

5. The handle according to claim 3, wherein the at least one mounting and/or dismounting means of the cover member and the at least one complementary mounting and/or dismounting means of the access part cooperate with each other by clipping.

6. The handle according to claim 3, wherein the cover element comprises a slot adapted for receiving a mechanical key such that the cover element can be rotated between the locked position and the unlocked position by the mechanical key.

7. The handle according to claim 3, further comprising a connecting element connecting the cover element to another part of the cover member so that the cover element remains connected to the cover member even when the cover element is moved with respect to the opening such that the mechanical lockset can be accessed.

8. The handle according to claim 3, wherein the cover member comprises guiding means configured to guide the cover element when the cover element is moved to the locked position.

9. The handle according to claim 8, wherein the guiding means comprises a guide rail and a guide shoe, the access part comprising the guide rail, and the cover element comprising the guide shoe, the guide shoe being configured to cooperate with the guide rail.

10. An assembly for opening and/or closing a vehicle door, the assembly comprising:
a bracket configured to be assembled to an inner side of the door, the bracket comprising at least one electronic switch configured to be activated by a user's touch to send a signal to an electronic latch to open the door; and
the handle according to claim 1.

11. A method for opening a vehicle door by means of the assembly of claim 10, the method comprising a step of moving the cover element from the locked position to the unlocked position by rotating the cover element with respect to the access part according to the opening axis.

12. The method of claim 11, further comprising the step of moving the cover element in the unlocked position away from to the opening such that the mechanical lockset can be accessed.
